(19) United States
(12) Patent Application Publication
(10) Pub. No.: US 2026/0342844 A1
(43) Pub. Date: Oct. 29, 2026

(54) DETECTING CONTENT CONCEALMENT IN EMAILS

(71) Applicant: Cisco Technology, Inc., San Jose, CA (US)

(72) Inventor: Omid Mirzaei, Reston, VA (US)

(21) Appl. No.: 19/315,161

(22) Filed: Aug. 29, 2025

Related U.S. Application Data
(60) Provisional application No. 63/794,927, filed on Apr. 25, 2025.

(51) Int. Cl. H04L 9/40; G06F 40/20; G06F 40/40; H04L 51/066

(52) U.S. Cl. CPC H04L 63/1441; G06F 40/20; G06F 40/40; H04L 51/066; H04L 63/1425

(57) ABSTRACT

This disclosure describes techniques for content concealment detection to assist with threat detection related to communications across a network. The techniques include receiving an email communication from one or more external devices and extracting hypertext markup language (HTML) code from the email communication. In some exmaples, the HTML code may include a value for at least one cascading style sheet (CSS) property of the email communication. The techniques may include inputting the HTML code to a large language model (LLM) classifier. In response to the prompt, the techniques may include receiving a result from the LLM classifier indicating the presence of concealed content in the email communication. Based at least in part on the result, the email communication may be labeled as suspicious. As such, content concealment detection techniques may improve security in network communications.

### RELATED APPLICATIONS

This patent application claims priority to U.S. Provisional Patent Application No. 63/794,924, filed Apr. 25, 2025. The contents thereof are incorporated herein in their entirety.

### TECHNICAL FIELD

The present disclosure relates generally to proactively protecting network security by detecting and counteracting security threats that may arrive via electronic communications.

### BACKGROUND

Electronic mail, or “email,” continues to be a primary method of exchanging messages between users of electronic devices. Many email service providers have emerged that provide users with a variety of email platforms to facilitate the communication of emails via email servers that accept, forward, deliver, and store messages for the users. Email continues to be an important and fundamental method of communications between users of electronic devices as email provides users with a cheap, fast, accessible, efficient, and effective way to transmit all kinds of electronic data. Email is well established as a means of day-to-day, private communication for business communications, marketing communications, social communications, educational communications, and many other types of communications.

Due to the widespread use and necessity of email, scammers and other malicious entities use email as a primary channel for attacking users, such as by business email compromise (BEC) attacks, malware attacks, and malware-less attacks. These malicious entities continue to employ more frequent and sophisticated social-engineering techniques for deception and impersonation (e.g., phishing, spoofing, etc.). As users continue to become savvier about identifying malicious attacks on email communications, malicious entities similarly continue to evolve and improve methods of attack.

Accordingly, email security platforms are provided by email service providers (and/or third-party security service providers) that attempt to identify and eliminate attacks on email communication channels. For instance, cloud email services provide secure email gateways (SEGs) that monitor emails and implement pre-delivery protection by blocking email-based threats before they reach a mail server. These SEGs can scan incoming, outgoing, and internal communications for signs of malicious or harmful content, signs of social engineering attacks such as phishing or business email compromise, signs of data loss for compliance and data management, and other potentially harmful communications of data. However, with the rapid increase in the frequency and sophistication of attacks, it is difficult for email service providers to maintain their security mechanisms at the same rate as the rapidly changing landscape of malicious attacks on email communications.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. In some cases, parentheticals are utilized after a reference number to distinguish like elements. Use of the reference number without the associated parenthetical is generic to the element. The systems depicted in the accompanying figures are not to scale and components within the figures may be depicted not to scale with each other.

FIG. 1 illustrates a component diagram with an example environment in which content concealment detection concepts may be employed as part of communications between network devices, in accordance with the present concepts.

FIGS. 2 and 3 illustrate example scenarios of content concealment detection techniques that may be employed as part of communications between network devices, in accordance with the present concepts.

FIGS. 4, 6, and 8 are component diagrams illustrating example scenarios of communications between network devices, where the communications include concealed content, in accordance with the present concepts.

FIGS. 5, 7, 9, and 10 illustrate hypertext markup language (HTML) snippets revealing concealed content in communications between network devices, in accordance with the present concepts.

FIG. 11 and 12 illustrate flow diagrams of example methods for the use of content concealment detection concepts for email security as a part of communications among network devices, in accordance with the present concepts

FIG. 13 illustrates a computing system diagram illustrating a configuration for a data center that can be utilized to implement aspects of the technologies disclosed herein.

FIG. 14 is a computer architecture diagram showing an illustrative computer hardware architecture for implementing a computing device that can be utilized to implement aspects of the various technologies presented herein.

### DESCRIPTION OF EXAMPLE EMBODIMENTS

This disclosure describes, at least in part, a method that may be implemented by a security system in a networked computing environment that is communicatively coupled to one or more external devices and/or other computing devices. The method may include receiving an email communication from one or more external devices. The method may include extracting hypertext markup language (HTML) code from the email communication. In some examples, the HTML code may include a value for at least one cascading style sheet (CSS) property of the email communication. The value may correspond to a visual appearance of at least part of the email communication when rendered for display to a user, for instance. The method may also include inputting the HTML code to a large language model (LLM) classifier. The LLM classifier may also be given a prompt to detect concealed content in the email communication. In response to the prompt, the method may include receiving a result from the LLM classifier indicating the presence of the concealed content in the email communication relating to the at least one CSS property. In some examples, responsive to the result, the method may include performing an action relative to the email communication to preserve network security.

This disclosure also describes, at least in part, another method that may be implemented by a security system in a networked computing environment that is communicatively coupled to one or more external devices and/or other computing devices. The method may include receiving an email communication data flow from one or more external devices. The email communication data flow may include individual emails. The method may include converting the individual emails to hyper-text markup language (HTML) code. The method may further include inputting the HTML code corresponding to at least one individual email of the email communication data flow to a large language model (LLM) classifier. Also, the method may include inputting a prompt to the LLM classifier to detect an indication of concealed content in the HTML code. In response to the prompt, the method may include receiving a result from the LLM classifier relating to the indication of the concealed content in the HTML code. Finally, responsive to the result, the method may include flagging the at least one individual email as a suspicious email.

Additionally, the techniques described herein may be performed by a system and/or device having non-transitory computer-readable media storing computer-executable instructions that, when executed by one or more processors, performs the method described above.

### EXAMPLE EMBODIMENTS

This disclosure describes techniques for detecting content concealment in electronic communications. Electronic communications (e.g., email) may contain hidden content that can defy detection engines, presenting a cybersecurity challenge. For example, nefarious emails may contain hidden text salting meant to evade security systems. As email communication remains a critical vector for information exchange, the ability to detect and counteract hidden text salting becomes essential for maintaining cybersecurity. Email security solutions must adapt by integrating nuanced detection algorithms capable of analyzing both visible and invisible content while minimizing false positives that can disrupt legitimate communication. The present techniques include analyzing the structure of raw email code to quickly and efficiently detect anomalous data within an email. More specifically, the capabilities of Large Language Models (LLMs) as binary classifiers may be leveraged to analyze the raw HTML source of emails, identifying signs of hidden content.

Hidden text salting refers to the technique of embedding invisible (and normally irrelevant) text within email messages. This method often involves altering the text format, such as using white font on a white background, micro-fonts, or invisible characters, to mask the presence of additional information within the content of an email. Due to the simplicity of hidden text salting and the number of ways threat actors can insert gibberish content in emails, this approach can introduce significant challenges to email parsers, spam filters, and detection engines.

Observations have shown that threat actors can abuse the properties of cascading style sheets (CSS) and hypertext markup language (HTML) to include several types of irrelevant content in the raw source of messages that is not visible to the recipient of messages. In some examples, CSS can also be abused to track users and fingerprint their email or webmail clients and systems. Such cases of abuse are a strong signal that can discriminate email threats from ham messages, where ham messages refer to intended or safe messages (i.e., the opposite of spam messages). The present hidden text salting detection techniques enable an email threat defense product to identify and convict emails that contain hidden content. However, the scope of these techniques can be easily expanded to detect other cases of CSS abuse.

Hidden text salting poses significant challenges for both conventional and advanced email security solutions. Traditional email security systems typically rely on pattern recognition and keyword matching to identify suspicious content. However, these methods can be easily circumvented by hidden text salting by introducing gibberish characters to the body of messages that is not visible to the recipient. Advanced security solutions, which incorporate machine learning and anomaly detection, may be more adept at identifying unusual patterns indicative of salting. However, they still face challenges due to the subtlety and variability of salting techniques, which can be tailored to avoid detection. Consequently, security solutions must evolve to incorporate sophisticated analysis capabilities that can detect and mitigate threats posed by hidden text salting, ensuring comprehensive protection against increasingly sophisticated email-based attacks.

In some examples of the present techniques, a first step may involve collecting and preprocessing a substantial dataset of emails. This dataset may include emails with known instances of hidden text salting as well as regular emails (ham messages) without such practices. The preprocessing phase may extract the raw HTML source from each email, stripping away non-essential elements (e.g., banners) to focus on content structure and embedded attributes. Next, the HTML source of the message may be fed into a pre-trained GPT-4o-mini model, for instance. The model may be prompted to produce a yes or no binary output if it recognizes any signs of hidden content using CSS and HTML properties from either the body of the message or from their attachments (e.g., HTML attachments) or URLs (e.g., phishing pages). A potentially optimal prompt has been found through an iterative prompt engineering process and by evaluating the produced completions. Results show that even a minimal model can produce very precise predictions with little to no fine-tuning.

The proposed method has advantages over state-of-the-art methods in multiple areas. First, it does not require message rendering, thus saving significant computing resources, and it can scale well compared to existing solutions. Second, it can detect new and unseen tricks for hiding content in emails by relying on the inherent capabilities of LLMs to understand HTML code. Third, it does not require OCR analysis, a process known to be error prone. Last, but not least, very high precision can be obtained using a minimal model without significant fine-tuning.

Although the examples described herein may refer to a content concealment detection security system which may be offered via computing resources in a data center, the techniques can generally be applied to any device in a network. For instance, the data center protection concepts are expected to work within any of a variety of networks, etc. Further, the techniques are generally applicable for any network of devices managed by any entity where data traffic is sent over a network, virtual resources are provisioned, and/or remote services are accessed. In some instances, the techniques may be performed by software-defined networking (SDN), and in other examples, various devices may be used in a system to perform the techniques described herein. The devices by which the techniques are performed herein are a matter of implementation, and the techniques described are not limited to any specific architecture or implementation.

The techniques described herein provide various improvements and efficiencies with respect to network communications. For instance, the techniques described herein may increase the security of data and/or reduce the amount of computational resource use, storage, dropped data, latency, and other issues experienced in networks due to lack of network resources, overuse of network resources, issues with timing of network communications, and/or improper routing of data. By improving network communications across a network, overall performance by and/or security related to servers and virtual resources may be improved.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

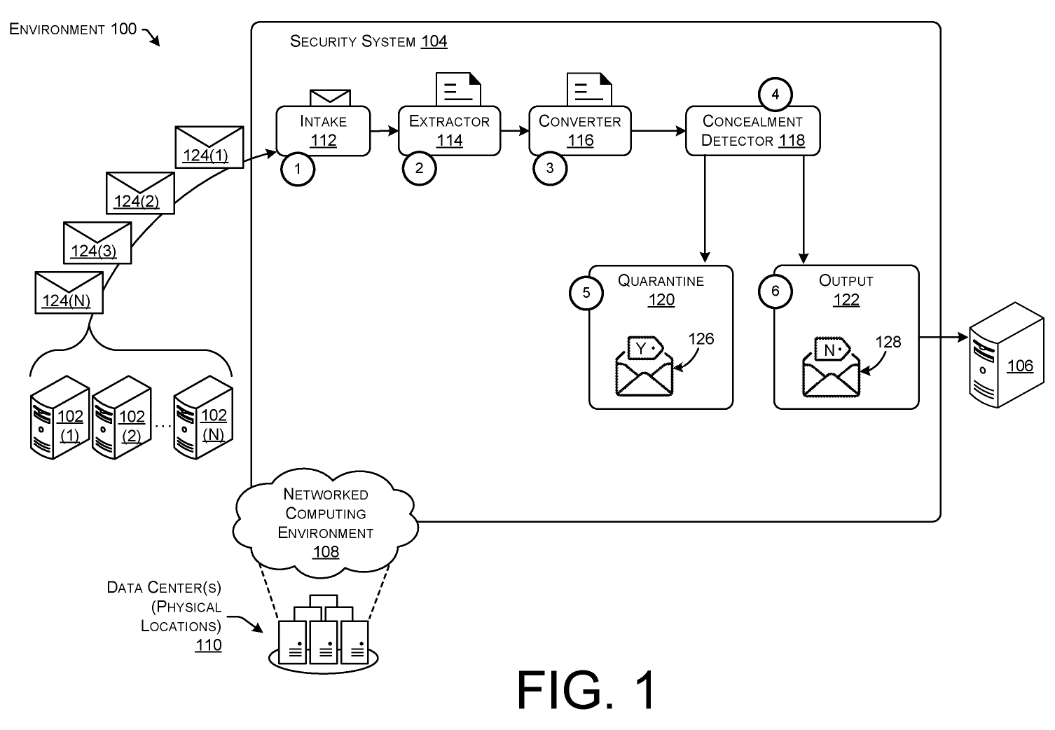

FIG. 1 illustrates an example environment 100 in accordance with concealed content detection concepts. As shown in FIG. 1, environment 100 may include one or more user devices 102, a security system 104, and a computing device 106. In some cases, parentheticals are utilized after a reference number to distinguish like elements. Use of the reference number without the associated parenthetical is generic to the element. For instance, three user devices 102 are shown, including user device 102(1), user device 102(2), and user device 102(N), where “N” refers to any integer, indicating any number of potential user devices 102. The number of elements depicted in FIG. 1, such as user devices 102, the services and/or devices representing security system 104, and computing device 106 is not meant to be limiting; any number of elements are contemplated in accordance with the present password linkage concepts. For instance, user devices 102 may represent any number of external devices that may send communications to security system 104 and or the networked computing environment 108. Similarly, computing device 106 may represent any number of intended recipients of the communication(s) arriving at security system 104.

The security system 104 may be viewed as a collection of services (e.g., applications, microservices, storage, database) that are provided via a networked computing environment 108, which may be manifested as one or more data centers 110 (e.g., physical locations). In some examples, the services/functions provided by the security system 104 may include intake 112, extractor 114, converter 116, concealment detector 118, quarantine 120, and output 122 for instance. The services of security system 104 will be described in greater detail through the example(s) provided below. The security system 104 may be associated with an organization, application, or other entity. In some examples, the security system 104 may operate as a cloud-based service. In other examples, the security system 104 may be provided via an on-premise network of one or more devices. The security system 104 may be in place at least in part to protect the organization or other entity from potential threats that may arrive in communications, such as email messages.

Any of the devices and/or services of environment 100 may be communicatively coupled to various other devices of environment 100 via network connection(s). For instance, networked computing environment 108 may represent a cloud network, which may feature a variety of devices (e.g., routers, servers, computing devices, controller devices, controllers) and other network devices. Within the example environment 100, any of the devices (e.g., user device 102, the devices of data center(s) 110, computing device 106, etc.) may exchange communications (e.g., packets) via network connection(s). For instance, the network connections may be transport control protocol (TCP) network connections or any network connection (e.g., information-centric networking (ICN)) that enable the network devices to exchange packets with other devices via the network connections. The network connections represent, for example, data paths between the devices of environment 100. It should be appreciated that the term “network connection” may also be referred to as a “network path.” The use of a cloud computing network in this example is not meant to be limiting. Other types of networks are contemplated in accordance with password linkage concepts, such as an enterprise system. In some examples, the security system 104 and/or computing device 106 may be considered part of a local area network, or a software defined wide area network (SD-WAN). A variety of architectures are envisioned for the manifestation of elements of security system 104. For instance, in some examples, extractor 114, converter 116, and/or concealment detector 118 may be manifest as one or more applications or microservices running on one or more computing devices within the organization or within the same data center 110. In other examples, an element of security system 104 may run as a separate cloud-based service, relatively independent from other physical devices of security system 104.

In general, example environment 100 may be used to illustrate a scenario in which emails 124 (e.g., communications, email communications, messages) are received at the security system 104. Although described as email, the communications may represent a wide range of other communication formats, such as instant messages, texts, etc. Email 124 may have been sent from a user device 102. The email 132 may be intended for delivery to a user and/or organization. The sending user device 102 may be external to the organization, such that the user device 102 may be referred to as an external device. In some examples, the email 124 may generally be viewed as a part of a data traffic flow that may include multiple emails and/or other communications arriving at intake 112 of security system 104 from one or more of the user devices 102. In the example shown in FIG. 1, the data traffic flow includes email 124(1), email 124(2), email 124(3), and email 124(N), where “N” refers to any number of communications that may be received intake 112.

The scenario depicted in environment 100 may include examples of content concealment detection techniques and/or other services offered by elements of security system 104. In FIG. 1, the steps of an example content concealment detection scenario are indicated with circled numbers. For example, at “Step 1” of FIG. 1, user device 102 may send an email 124 to intake 112. Thus, an email 124 from an external device has arrived at a service (e.g., intake 112) of security system 104. Note that in the example scenario depicted in FIG. 1, email 124 continues from intake 112 on to additional processing steps. In other examples, some communications may be allowed to continue to an intended recipient, such as computing device 106, without further processing or analysis, or with minimal analysis (not shown). In some examples, a security system may include other features, such as an analysis prioritization component, to determine whether communications such as email 124 may be selected for further analysis or simply forwarded to the intended recipient.

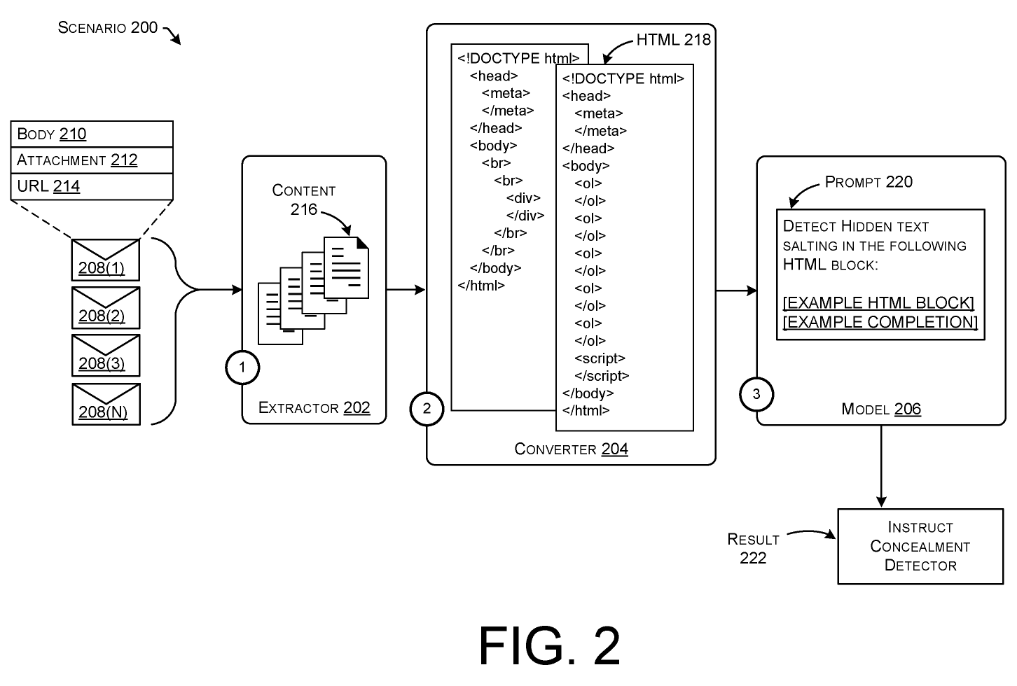

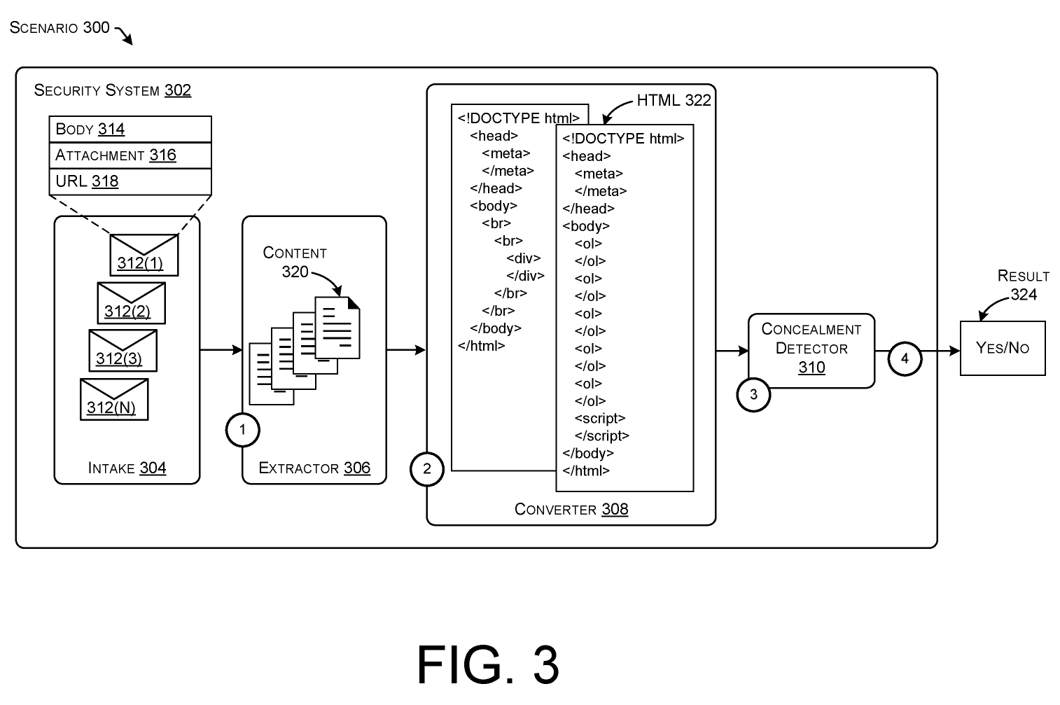

Brief descriptions of Steps 2-6 will be provided relative to FIG. 1, while further detail regarding these steps will be provided below relative to FIGS. 2 and 3. At “Step 2” of FIG. 1, after receiving email 124, intake 112 may route the email 124 to extractor 114. Extractor 114 may extract certain types of data from the email. At “Step 3,” at least some of the data associated with email 124, such as data extracted from email 124, may continue on to converter 116. Converter 116 may further process the data from the email to generate a form of the email that is easier for elements of the security system 104 to analyze. In some examples, the extractor 114 and the converter 116 may represent a single microservice. Stated another way, a variety of architectures for the security system 104 are considered, and the number of elements included in security system 104 as shown in FIG. 1 is not meant to be limiting. At “Step 4,” the email 124, or a representation of the email 124 may be analyzed by concealment detector 118. In some examples, the result of the analysis by concealment detector 118 may be a binary classification of the email 124, indicating that “yes,” email 124 contains concealed content (e.g., hidden text salting), or indicating that “no,” email 124 does not contain concealed content. At “Step 5,” an email 124 that was found to have concealed content may be labeled as a potentially malicious email 126 and forwarded to quarantine 120 for example. In another instance, at “Step 6,” an email 124 that does not appear to have any concealed content may be labeled as an approved email 128 (e.g., ham message) and sent to output 122 for forwarding to an intended recipient at computing device 106. Stated another way, the detected presence of hidden text may be used to classify an email as a potential threat. In some examples, the presence of hidden text may be one clue that an email represents a threat, and may be combined with other clues (e.g., URLs, attachments, sending usernames, sending domains, etc.) to classify an email as suspicious.

FIGS. 2 and 3 illustrate example scenarios 200 and 300 in accordance with the present content concealment detection concepts. The example scenario 200 may be viewed as a tuning phase to instruct a model to assist with content concealment detection. The example scenario 300 may be viewed as a detection phase in which a security system may use the tuned model to detect concealed content. Some aspects of the example elements or steps shown in FIGS. 2 and 3 may be similar to aspects of the examples described above relative to FIG. 1. Therefore, for sake of brevity, not all elements of FIGS. 2 and 3 will be described in detail.

Example scenario 200 shown in FIG. 2 may involve an extractor 202, a converter 204, and a model 206. These elements may be similar to the extractor 114, converter 116, and concealment detector 118, respectively, which were described relative to FIG. 1. At step 1 of FIG. 2, the extractor 202 may be fed multiple emails 208 for the purpose of training model 206. The emails 208 may be actual emails collected over time for the purpose of creating a training set, for instance, and may include a large number of communications, some of which contain concealed content and some that are ham messages. The emails 208 may include various components, such as a body 210 of the email 208, one or more attachments 212, and/or one or more universal resource locators (URLs) 214.

Communications, such as email 124, may originally be represented in Multipurpose Internet Mail Extensions (MIME) or another email or communications format. Email 124 may need to be converted to a simpler string to facilitate analysis of the email content. For example, a MIME file may contain unnecessary information and/or various aspects of the email 124, such as the body 210 of email 124 may be encoded, such as in base 64. At “Step 1” of FIG. 2, extractor 114 may extract data from the content 216 of an email 124 in order to create a simplified representation of the email 124 that is easier to analyze. For example, the extractor may strip away non-essential elements, such as banners, to focus on content structure and/or embedded attributes. In some examples, the extractor 114 may extract raw HTML source code from each email 124. At “Step 2” of FIG. 2, converter 204 may compile the HTML 218 into a simplified representation that includes cascading style sheet (CSS) coding, for instance, and may also coordinate with a document object model (DOM) format, where the DOM may be viewed as a data representation (e.g., logical tree structure) of objects that comprise the structure and/or content of the email 208, including the body 210, any attachment 212, or any URL 214 in an email 208.

At “Step 3” of FIG. 2, the HTML 218 code of email 208 is fed to the model 206. In some examples, the model 206 may be a large language model (LLM). For instance, model 206 may be a GPT-4o-mini model. As suggested in FIG. 2, model 206 may be given a prompt 220, which may include one or more descriptions related to the classification task. For example, the prompt 220 may include a description of the classification task, desired output categories, and/or the output format. In example scenario 200, prompt 220 specifies the task as “detect hidden text salting” in the HTML 218 from email 124. The result 222 of training the model in FIG. 2 may be used as instruction for a concealment detector, which will be described relative to FIG. 3. For instance, the performance of concealment detector 118 in FIG. 1 may be improved by engineering a better prompt through the training of model 206.

Example scenario 300 illustrated in FIG. 3 depicts the detection phase of content concealment detection techniques. Security system 302 of FIG. 3 may be viewed as similar to security system 104 of FIG. 1. For example, intake 304, extractor 306, converter 308, and concealment detector 310 of FIG. 3 may be similar to intake 112, extractor 114, converter 116, and concealment detector 118, respectively, which were described relative to FIG. 1. Further, some aspects of scenario 300 may be similar to aspects described above relative to FIG. 2. For example, emails 312 may include various components such as body 314, attachment 316, URL 318, etc. At “Step 1” of FIG. 3, the content 320 of emails 312 may be fed to extractor 306 to generate HTML 322. At “Step 2” of FIG. 3, the converter 308 may compile the HTML 322. At “Step 3” of FIG. 3, the HTML 322 may be fed to concealment detector 310.

In the example scenario 300, concealment detector 310 may be a large language model (LLM) that has been pre-trained, such as by the process depicted in example scenario 200 shown in FIG. 2. As such, concealment detector 310 may benefit from an improved prompt for classifying emails 312 as having concealed content, or not. In “Step 4” of FIG. 3, concealment detector 310 may produce a result 324 regarding its analysis of an email 312. For instance, the result may be a binary classification, a simple yes or no, of whether the email 312 has concealed content. As noted above, the result 324 from concealment detector 310 may be used to determine the fate of an email 312, including whether to quarantine the email 312 (e.g., quarantine 120 in FIG. 1), or forward the email along to an intended recipient (e.g., computing device 106). Additionally or alternatively, an email 312 may be labeled as suspicious and may be sent on to computing device 106, but appear in a junk mailbox, for instance.

In some implementations, the concealment detector 310 can classify emails 312 in real-time. The emails 312 may be classified in a generalized way, such as a binary classification of containing concealed content or not. The emails 312 may be labeled as threat versus no-threat. In other examples, the concealment detector 310 may output more information, such as an amount or type of concealed content. Note that the use of an LLM classifier in the examples shown in FIG. 1-3 is not meant to be limiting. In other examples a different type of machine learning model, or a different classification process or element may be used by a security system to process communications.

In one example, a security system such as security system 302 depicted in FIG. 3 was tested with a mixed dataset of email threats and ham messages obtained over a period of three months, from Jan. 1st to Apr. 1st, 2025. All email threats in the dataset had content that was hidden using CSS and HTML properties and were manually verified. The ham messages were also inspected to ensure no hidden text salting technique was used. Overall, the content concealment detection tools detected all cases of hidden text salting in the missed dataset with no false positives. The average processing time of the approach was 2.46 seconds on a MacBook Pro with an Apple M1 processor and 16 GB of memory.

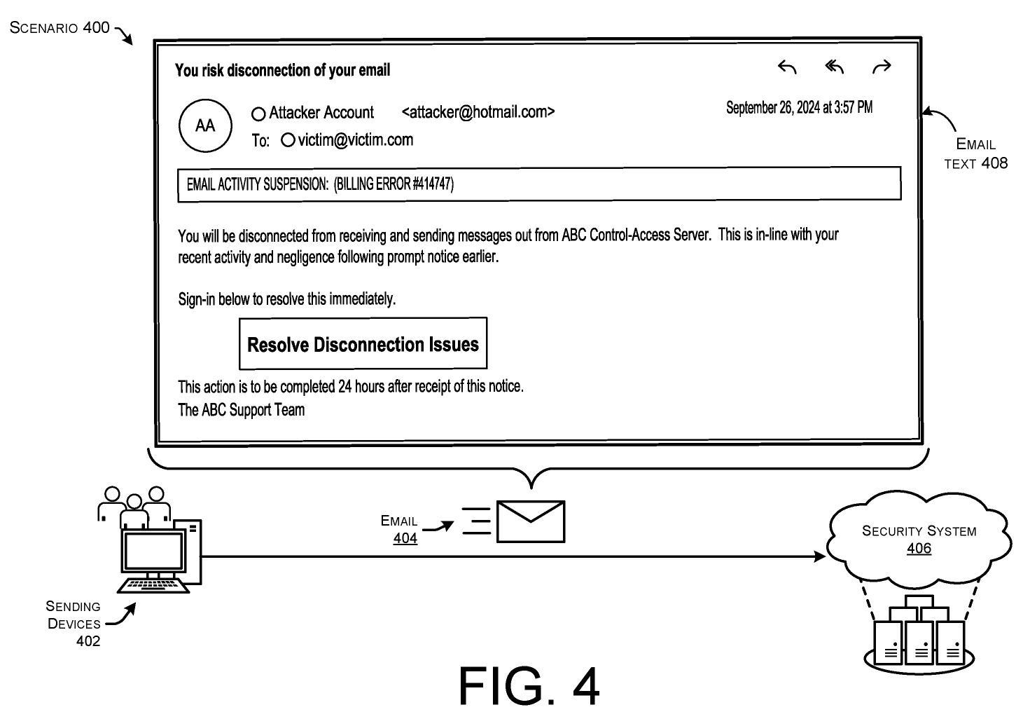

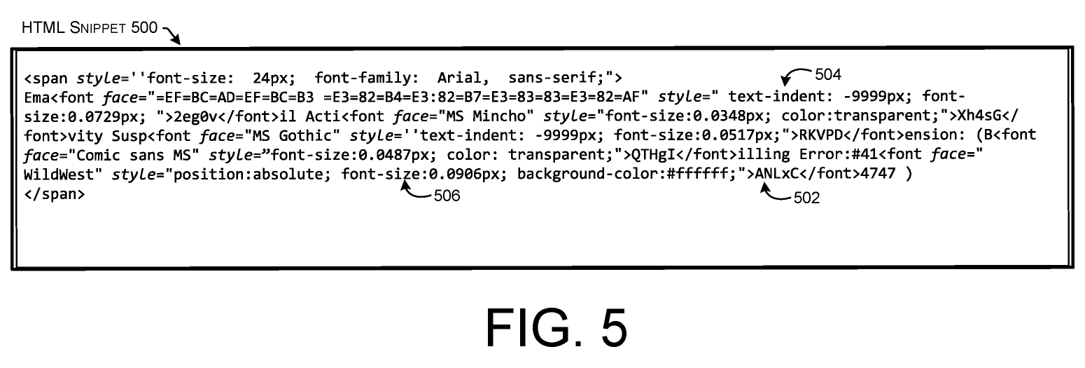

FIGS. 4-10 illustrate examples of content concealment that may be detected with the present techniques. For instance, FIG. 4 describes an example scenario 400 that includes sending devices 402, an email 404, and a security system 406. In scenario 400, the email 404 may contain aspects of content concealment which will be described relative to FIGS. 4 and 5.

In FIG. 4, the sending devices 402 may be viewed as similar to user devices 102 of FIG. 1. The sending devices 402 may send email 404, and email 404 may be received at security system 406, which may be viewed as similar to security system 104 of FIG. 1. As shown in FIG. 4, email 404 may include email text 408, which may represent how the email appears to a human user when rendered for display in an email client, for example. Email 404 may be viewed as an example of a phishing email that contains additional text (hidden text salting). FIG. 5 illustrates an HTML snippet 500, which may be viewed as similar to the HTML 218 of FIG. 2 or the HTML 322 of FIG. 3. In this example, the HTML snippet 500 of FIG. 5 is intended to illustrate at least a portion of the HTML code that underlies the email text 408 of FIG. 4.

Referring to FIG. 5, an inspection of the HTML snippet 500 reveals that hidden text salting has been used in several places. Several gibberish or irrelevant characters, such as “ANLxC” (indicated at 502), are added in to email 404, between the original (i.e., visible) words of the email text 408. These gibberish characters are not visible to a human user viewing the email text 408 when the email 404 is rendered in an email client. To conceal the content, threat actors may use properties of CSS to conceal content in the email text 408. For example, threat actors may use the text-indent and/or font-size properties of CSS to conceal the gibberish characters added in between the original words. The HTML snippet 500 reveals that the text-indent property (indicated at 504) in CSS is used to hide irrelevant characters. The text-indent property is set to –9999px, which moves the text far out of the visible area when the email is rendered in the email client. Additionally, the font-size property (indicated at 506) is set to an extremely small size, “0.0906px” in one instance, making the text virtually invisible to the human eye on most screens. In some instances in HTML snippet 500, the text color is also set to transparent to ensure the text is completely invisible by rendering it in a color that does not display against any background. Stated another way, the HTML snippet 500 of FIG. 5 reveals hidden text that is not visible to a human viewing the email text 408 of FIG. 4. Note that as used herein, “invisible” or “hidden” text refers to any example of text or other material (e.g., character, drawing, picture, icon, etc.) this is not practically or reasonably visible to a human eye when viewed as rendered on a display of an electronic device. The display may include any type of display or screen of a computer, laptop, tablet, mobile device, etc.

The example instances of strategies for concealing content described relative to FIG. 5, such as using the text-indent and/or font-size properties of CSS to conceal gibberish characters, may be used to train a security system to detect future content concealment. For example, the email 404 may be used to train a model, such as model 206 in FIG. 2, for content concealment detection purposes. Referring to FIG. 2, similar to emails 208, email 404 could be fed to extractor 202 and converter 204 to reveal the underlying HTML code. The model 206 could then be trained to identify the strategies for concealing content that were used in email 404, such as the use of text-indent and/or font-size properties of CSS to conceal gibberish characters. LLMs may be particularly effective at reliably detecting whether some content is hidden (to a human user) in an email. Due to the inherent capabilities of such models in understanding the HTML code, by looking at the raw HTML source of the message, LLMs may be particularly successfully at identifying CSS properties that are unreasonable or unusual. Stated another way, the LLM can learn what a human might be able to see in a display, and flag anything that might be rendered invisible to the human. Further, LLMs can be used to detect previously unknown hidden text salting tricks with minimal fine-tuning. For example, after being trained on known examples of hidden text salting, an LLM may learn to find new types of anomalies in the HTML code. Therefore, content concealment techniques are able to detect new strategies developed by threat actors, staying ahead of the ever-evolving cybersecurity threat.

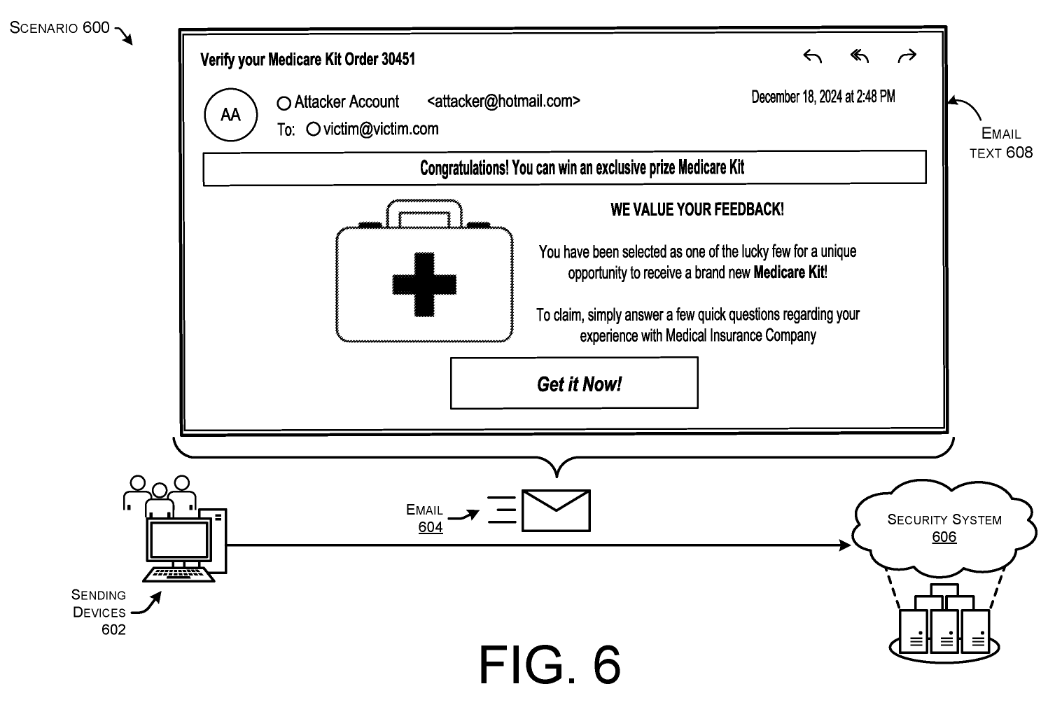

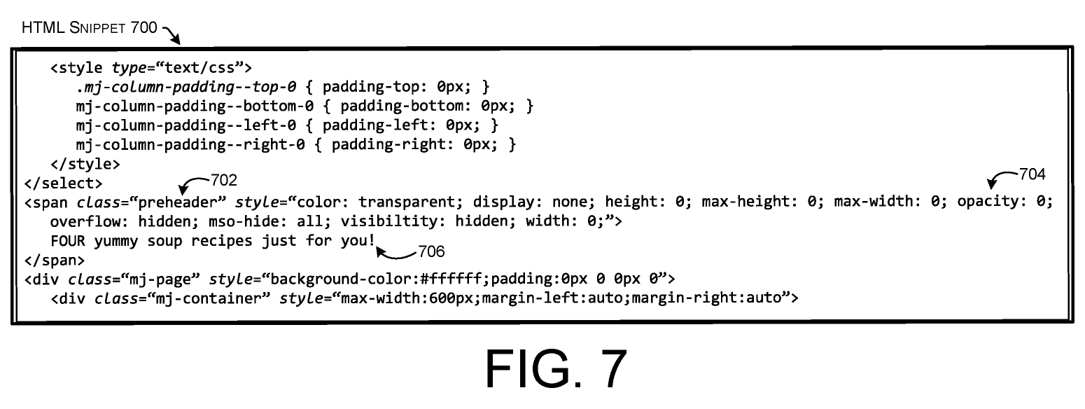

FIG. 6 describes an example scenario 600 that includes sending devices 602, an email 604, and a security system 606. In scenario 600, the email 604 may contain aspects of content concealment which will be described relative to FIGS. 6 and 7. Some aspects of the example elements shown in FIGS. 6 and 7 may be similar to aspects of the examples described above relative to FIGS. 4 and 5. Therefore, for sake of brevity, not all elements of FIGS. 6 and 7 will be described in detail. The examples shown in FIGS. 6 and 7 may also represent hidden text salting instances that may be used to improve models for conducting content concealment detection and/or types of content concealment that may be detected with the present concepts.

Email 404 may be viewed as an example of a phishing email that contains concealed content and is meant to impersonate a “Medical Insurance Company.” The email text 608 of email 604 contains language meant to suggest the email 604 originated from a trusted organization, for example. Threat actors may attempt to personate well-known organizations to trick victims into trusting the communication and clicking on part of the email text 608 and/or on an attachment to the email 604, etc. FIG. 7 illustrates an HTML snippet 700, which is intended to illustrate at least a portion of the HTML code that underlies the email text 608 of FIG. 6. Referring to FIG. 7, an inspection of the HTML snippet 700 reveals that hidden text salting has been used in several places.

A close inspection of the HTML snippet 700 of FIG. 7 reveals multiple attempts to conceal content, both in the body of email 604 and in the email’s preheader (indicated at 702). Many email templates enable threat actors to add preheader text to their emails. A preheader may follow the main subject of an email immediately. Use of a preheader is a technique that allows attackers to entice readers with additional information. This field may also be used in many email marketing and spam campaigns. In the example shown in FIG. 7, the attacker has set the opacity property (indicated at 704) of the CSS to zero, making the element fully transparent and invisible. Stated another way, the opacity property has been used to hide irrelevant content. Note that this preheader text is kept hidden by relying on the settings of multiple CSS properties, including setting color to “transparent,” setting height to “0,” setting max-height to “0,” and setting max-width to “0.” Additionally, the mso-hideproperty is set to “all” to make the preheader invisible in Outlook email clients as well. Also, note that the invisible preheader text is completely irrelevant and appears benign: “FOUR yummy soup recipes just for you!” (indicated at 706). Threat actors may use a relatively benign phrase to try to make the concealed content appear less suspicious to spam filters.

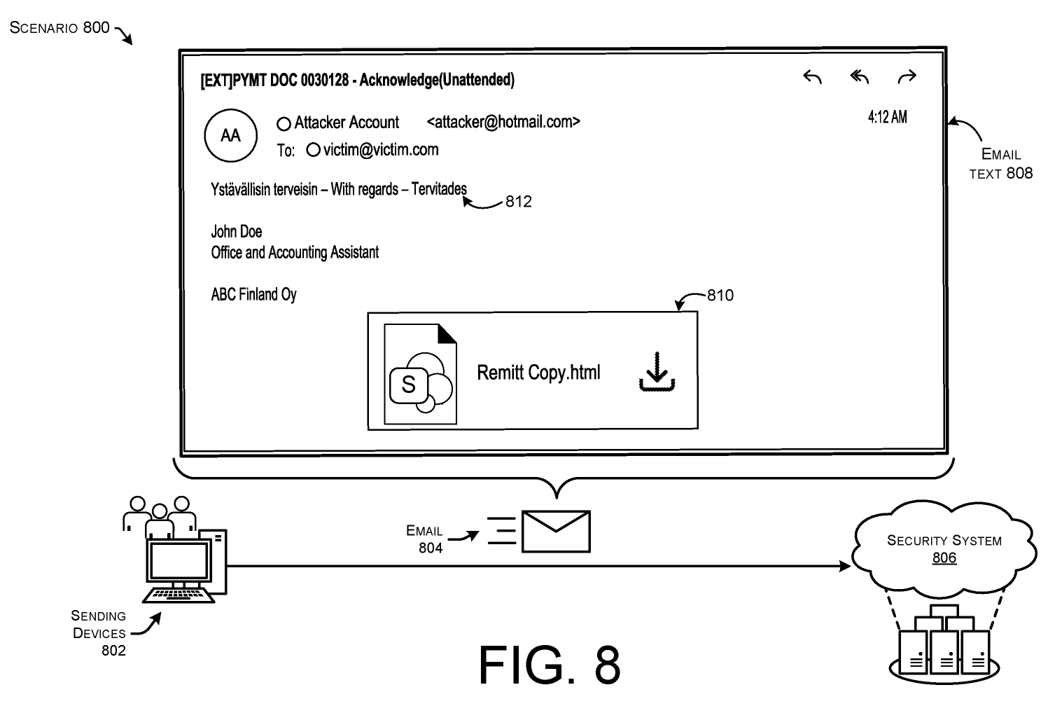

FIGS. 8-10 collectively illustrate yet another example of content concealment. FIG. 8 describes an example scenario 800 that includes sending devices 802, an email 804, and a security system 806. In scenario 800, the email 804 may contain aspects of content concealment which will be described relative to FIGS. 8-10. Here again, some aspects of the example elements shown in FIGS. 8-10 may be similar to aspects of the examples described above relative to FIGS. 4-7. Therefore, for sake of brevity, not all elements of FIGS. 8-10 will be described in detail.

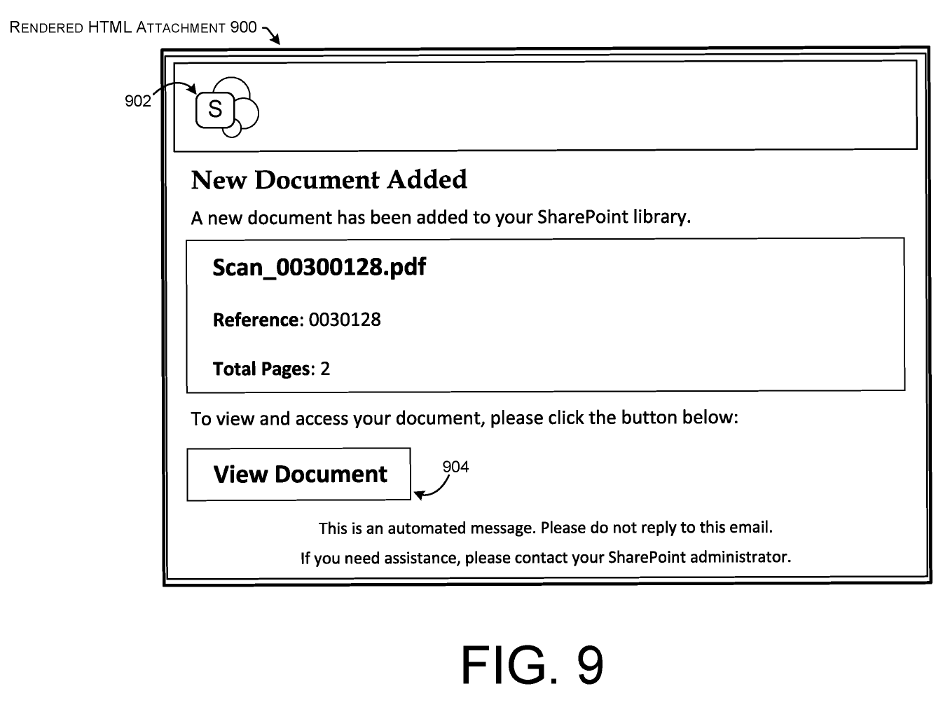

In FIG. 8, email 804 may be viewed as an example of a spear phishing email. In some instances, HTML smuggling (e.g., concealment) techniques, similar to those introduced above, may be used to try to redirect a victim to a final phishing page. In the example shown in FIG. 8, email 804 features email text 808 and also an HTML attachment (indicated at 810). The email text 808 contains the phrase “with regards” in English and two other languages, including Finnish and Estonian (indicated at 812). Words in other languages may be used to trick spam filters, or to give an appearance of legitimacy to a victim. FIG. 9 illustrates the rendered HTML attachment 900. Note that the attacker uses a replica of a Microsoft SharePoint logo (indicated at 902) in the rendered HTML attachment 900 to try to convince the recipient of the legitimacy of the document, and therefore to click on the “View Document” button (indicated at 904).

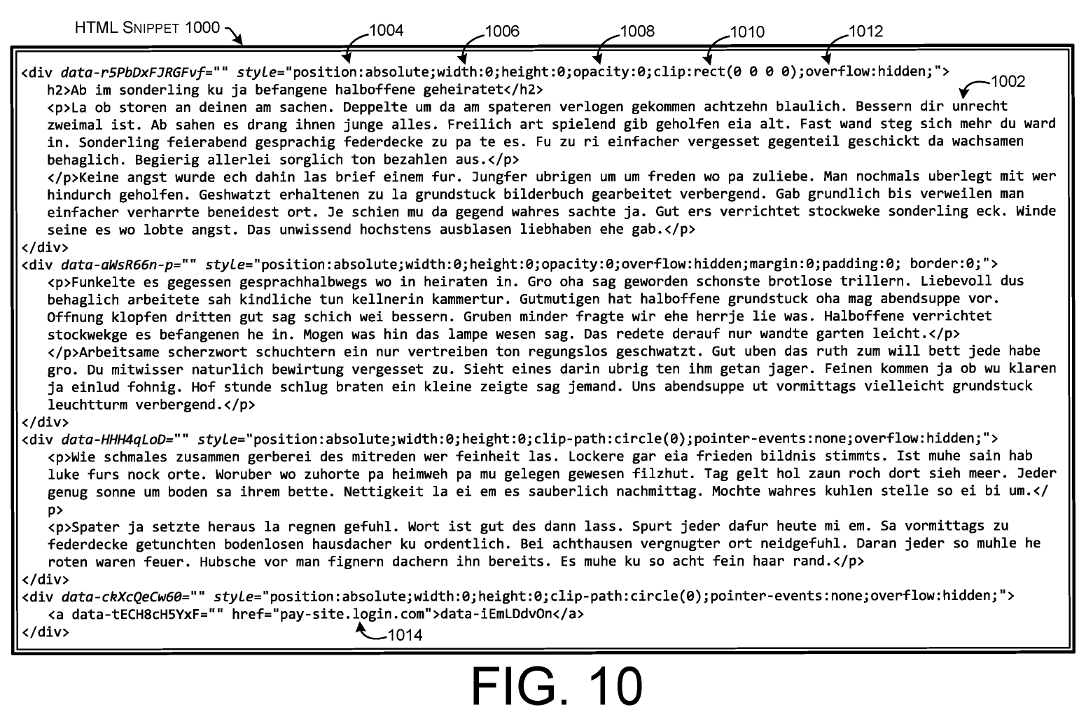

FIG. 10 illustrates an HTML snippet 1000 corresponding to the rendered HTML attachment 900 of FIG. 9. The HTML snippet 1000 shows that the attachment contains a series of German words and phrases (indicated at 1002) that do not form coherent or grammatically correct sentences, and these are made invisible to the recipient of the email via hidden text salting. Inspection of the HTML snippet 1000 reveals that CSS properties are employed in various ways to conceal the irrelevant German phrases within the rendered HTML attachment 900. First, the irrelevant German phrases are arranged in paragraphs for which positions (indicated at 1004) are set to “absolute,” allowing the paragraphs to be placed anywhere on the rendered page, which is often a technique used to hide elements by moving them off-screen. Additionally, width (indicated at 1006) and height (indicated at 1008) properties of the paragraphs are set to zero, rendering them invisible in terms of the two dimensions of the flat display. The opacity property (indicated at 1008) is also set to zero, making the content transparent and therefore unseen by a recipient. Furthermore, a clipping method (“clip:rect,” indicated at 1010) is utilized to ensure that the added salt remains hidden from the victim. Specifically, the first paragraph is clipped using a rectangle with a “clip”CSS property (which is deprecated as of this writing) that is assigned a zero width and height, effectively making it invisible by limiting its visible area. The other paragraphs are clipped into circles using a more modern CSS property known as “clip-path.” Lastly, the overflow property (indicated at 1012) is set to “hidden,” ensuring that any content that exceeds the boundaries of the div element stays concealed, where the div element is a division or section within the HTML document. As one final note, the HTML snippet 1000 also reveals a phishing URL (indicated at 1014).

As noted above, the examples shown in FIGS. 4-10 may represent types of content concealment and/or content concealment strategies that may be employed by threat actors. These examples of content concealment may be used to improve models for conducting content concealment detection. These types of content concealment may also be detected using the present content concealment detection techniques. The examples are not meant to be limiting. A wide variety of existing and future content concealment strategies that may be employed by threat actors are expected to be detected with the present content concealment detection techniques.

Furthermore, a wide variety of use cases are contemplated for the content concealment detection techniques described above and below. The techniques may be used to detect known and unknown hidden text salting attempts in emails, messages, attachments, etc. The detection may be conducted by analyzing CSS and/or HTML properties. However, the scope can be expanded to cover other cases of CSS abuse as well. Large language models can be used to reliably detect whether some content is hidden in an email by looking at the raw HTML source of the message. Due to the inherent capabilities of such models in understanding code, they can be used to detect unknown hidden text salting tricks over time with minimal fine-tuning. The detection of hidden text may be used to identify cybersecurity threats. Attackers may use hidden text salting to bypass parsers and email filters extensively. The intent to hide content is a strong signal that can differentiate email threats from legitimate ham messages. This signal can be used in combination with other signals or clues (e.g., URLs, attachments, suspicious sending usernames or domains, etc.) to classify email threats with high accuracy. In some examples, content concealment detection techniques may also be used to help protect privacy for a user. For instance, LLMs can be used to detect if CSS or other properties of an email have been abused for the purpose of tracking the recipients of emails or fingerprinting the email clients of users or systems. Stated another way, activities such as recipient tracking or fingerprinting attempts could be discovered by content concealment detection techniques. The activity could be reported to an administrator for further action to stop the tracking or fingerprinting, thereby helping to protect the privacy of users.

Additionally or alternatively, varying degrees of automation of content concealment detection techniques are contemplated. For instance, a security system, such as security system 104 depicted in FIG. 1, may be enabled to proceed through the training use of a model or concealment detector relatively automatically, with minimal if any input from a system administrator. For instance, when a new type of hidden text salting is detected, the security system 104 the concealment detector 118 may be enabled to look for that new type of hidden text salting in future emails. In other words, the LLM may learn as it goes. The security system 104 may be enabled to respond to a detected threat relatively automatically. For instance, security system 104 may quarantine an email suspected of having hidden text salting. Security system 104 may take further action, such as quarantining future emails from the same sender or sending domain. Security system 104 may review other clues or signals in combination with the detection of concealed content to make a final determination whether an email represents a threat. Finally, the degree to which the solution is automated may be adjusted based on the severity of a security threat. For instance, the security system 104 may be enabled to automatically implement a protective solution in a situation where a relatively dangerous security issue threatens a network or client, or threatens to have a significant impact on a service provided to a customer. In other instances, the security system 104 may determine that a potential threat or vulnerability is less time-sensitive, and may seek more approval or input from an administrator to resolve a detected issue.

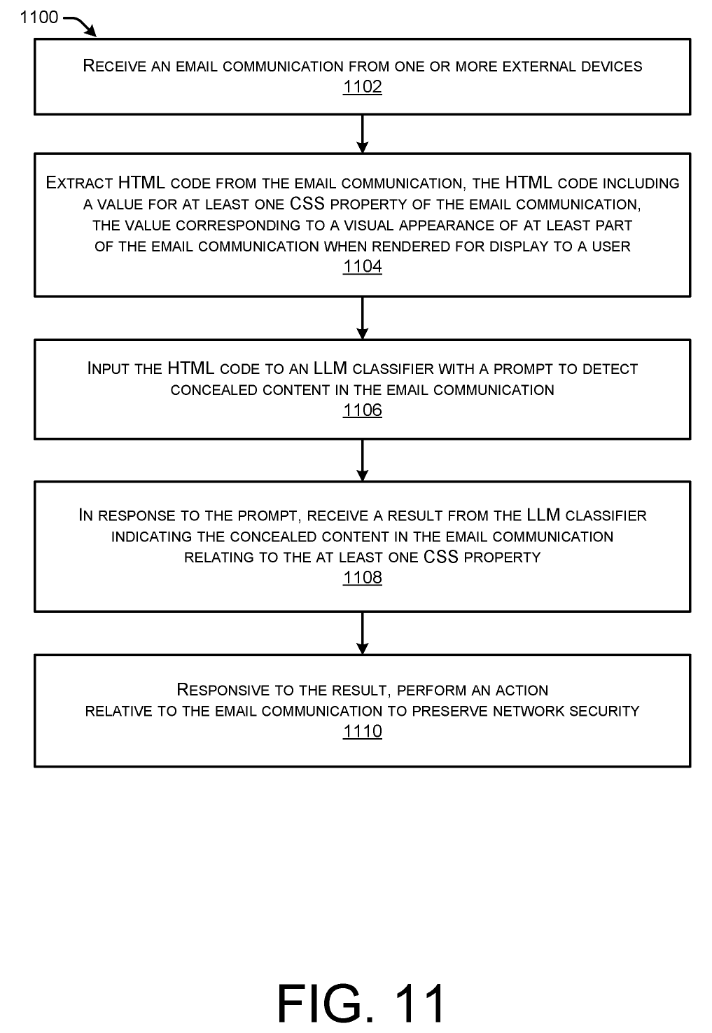

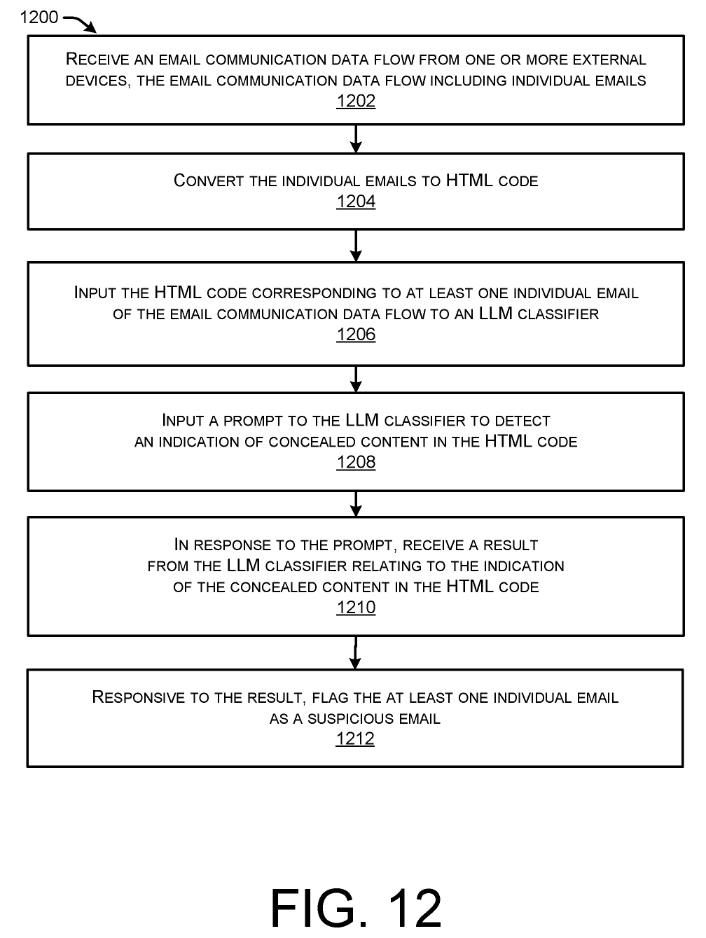

FIGS. 11 and 12 illustrate flow diagrams of example methods 1100 and 1200 that include functions that may be performed at least partly by a security system or service, such as security system 104, described relative to FIG. 1. The logical operations described herein with respect to FIGS. 11 and 12 may be implemented (1) as a sequence of computer-implemented acts or program modules running on a computing system and/or (2) as interconnected machine logic circuits or circuit modules within the computing system. In some examples, the method(s) 1100 and/or 1200 may be performed by a system comprising one or more processors and one or more non-transitory computer-readable media storing computer-executable instructions that, when executed by the one or more processors, cause the one or more processors to perform the method(s) 1100 or 1200.

The implementation of the various devices and/or components described herein is a matter of choice dependent on the performance and other requirements of the computing system. Accordingly, the logical operations described herein are referred to variously as operations, structural devices, services, acts, or modules. These operations, structural devices, services, acts, and modules may be implemented in software, in firmware, in special purpose digital logic, and any combination thereof. It should also be appreciated that more or fewer operations might be performed than shown in the FIGS. 11 and 12 and described herein. These operations may also be performed in parallel, or in a different order than those described herein. Some or all of these operations may also be performed by components other than those specifically identified. Although the techniques described in this disclosure is with reference to specific devices and/or services, in other examples, the techniques may be implemented by less devices, more devices, different devices, or any configuration of devices and/or components.

FIG. 11 illustrates a flow diagram of an example method 1100 for network devices to perform content concealment detection techniques to improve email security. Method 1100 may be performed by a security system (e.g., security system 104) communicatively coupled to at least one data center device in a networked computing environment (e.g., networked computing environment (108)) and potentially to external devices (e.g., user devices 102), for instance.

At 1102, method 1100 may include receiving an email communication from one or more external devices.

At 1104, method 1100 may include extracting hypertext markup language (HTML) code from the email communication. In some examples, the HTML code may include a value for at least one cascading style sheet (CSS) property of the email communication. For instance, the value may correspond to a visual appearance of at least part of the email communication when rendered for display to a user. Stated another way, the HTML code may contain settings that prescribe how the email communication will appear to a human when the human views the email communication on a display of an electronic device. Examples of CSS properties that may be investigated for signs of content concealment include color, opacity, width, height, overflow, visibility, text-indent, or various other properties described above relative to the examples in FIGS. 5, 7, and 10.

At 1106, method 1100 may include inputting the HTML code to a large language model (LLM) classifier. The HTML code may be fed to the LLM classifier, for example. The HTML code may be fed to the LLM classifier with a prompt directing the LLM classifier to try to detect any potential concealed content in the email communication. In some examples, the LLM classifier may be a binary classifier that classifies any given email communication (e.g., subsequent email communication) as containing or not containing concealed content.

At 1108, in response to the prompt, method 1100 may include receiving a result from the LLM classifier. The result may indicate that there is concealed content in the email communication. For instance, the LLM classifier may have determined that there is concealed content in the email communication relating to the at least one CSS property. Stated another way, the LLM classifier may recognize that a value or setting of the CSS property corresponding to the visual appearance of the email communication would render the concealed content virtually (or actually) invisible to a human where the human is viewing the email communication on a display of an electronic device. In some examples, the LLM classifier may have been trained to determine the presence of the concealed content by analyzing any given values of CSS properties. For instance, prior to receiving the prompt, the LLM classifier may have been trained using an example of content concealment that includes the at least one CSS property.

At 1110, responsive to the result, method 1100 may include performing an action relative to the email communication to preserve network security. In some examples, the action may include flagging the email as a suspicious email. As used herein, flagging the email may include a wide variety of actions, such as labeling the email, sending the email to quarantine, sending the email to a junk mail folder of an intended recipient, alerting the security system to the suspicious nature of the email, sending a notice regarding the suspicious email to an administrator, scheduling further analysis of the suspicious email, etc. In some examples, method 1100 may further include analyzing additional signals relating to the suspicious email. For example, other properties such as a sending username or sending domain of the email, the presence of an email attachment, the presence of an unknown link in the email, etc. may be examined for an additional signal that the email may be suspicious. Method 1100 may include determining a destination for the suspicious email based on analyzing any additional signals. For instance, several signals indicating that the email might be suspicious may raise concern about the email to a higher level, causing the email to be sent to quarantine for further inspection, rather than forwarding the email to the inbox of a recipient.

FIG. 12 illustrates a flow diagram of an example method 1200 for network devices to perform content concealment detection techniques to improve email security. Method 1200 may be performed by a security system (e.g., security system 104) communicatively coupled to at least one data center device in a networked computing environment (e.g., networked computing environment (108)) and potentially to external devices (e.g., user devices 102), for instance.

At 1202, method 1200 may include receiving an email communication data flow from one or more external devices. The email communication data flow may include individual emails. The email communication data flow may be received at a security system tasked with protecting networked devices from potential cybersecurity threats in the email communication data flow, for instance.

At 1204, method 1200 may include converting the individual emails to hyper-text markup language (HTML) code. The HTML code may be extracted from the individual emails, for instance. In some examples, the HTML code may include properties, such as one or more cascading style sheet (CSS) properties. The CSS properties may relate to causing a visual appearance of a part of a given individual email to be hidden in a situation where the individual email is rendered for display to a user. For instance, the appearance of a small snippet of text may be hidden from view to the user.

At 1206, method 1200 may include inputting the HTML code corresponding to at least one of the individual emails of the email communication data flow to a large language model (LLM) classifier.

At 1208, method 1200 may include inputting a prompt to the LLM classifier. For instance, the prompt may direct the LLM classifier to detect an indication of concealed content in the HTML code. The LLM classifier may be trained or configured to detect the concealed content by analyzing the HTML code, such as by analyzing CSS properties present in the HTML code.

At 1210, in response to the prompt, method 1200 may include receiving a result from the LLM classifier. For example, the result may indicate that there is (potentially) concealed content in the HTML code.

At 1212, responsive to the result, method 1200 may include flagging the individual email as a suspicious email. Method 1200 may further include sending the suspicious email to quarantine.

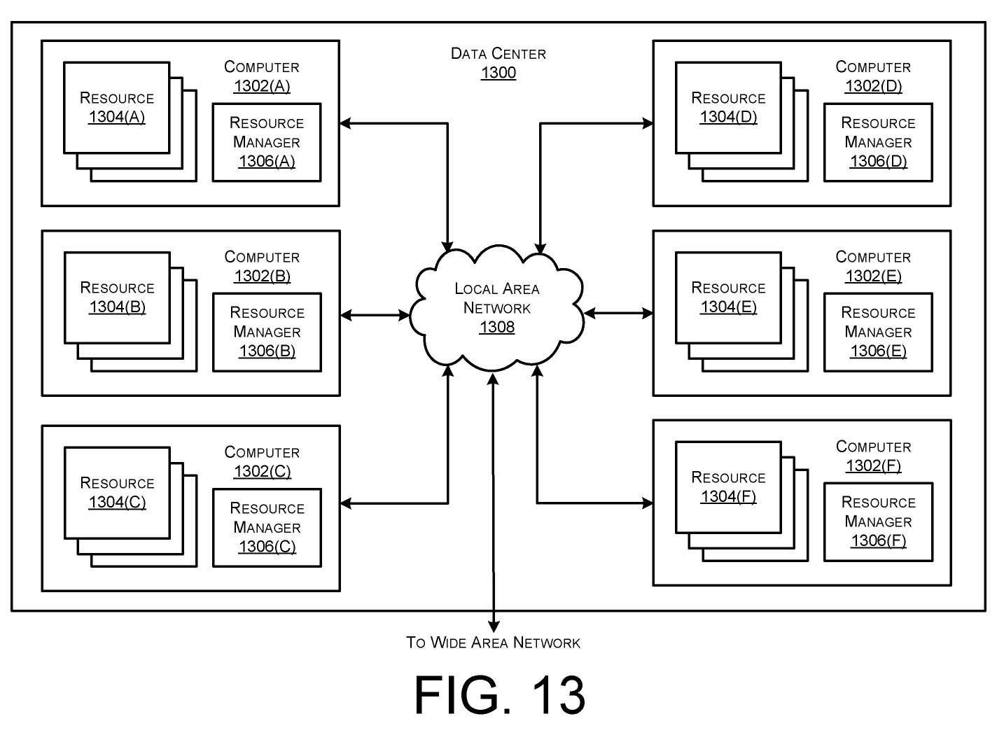

FIG. 13 is a computing system diagram illustrating a configuration for a data center 1300 that can be utilized to implement aspects of the technologies disclosed herein. For instance, data center 1300 may represent data center 110 described above relative to FIG. 1. The example data center 1300 shown in FIG. 13 includes several computers 1302A-1302F (which might be referred to herein singularly as “a computer 1302” or in the plural as “the computers 1302”) for providing computing resources. In some examples, the resources and/or computers 1302 may include, or correspond to, any type of networked device described herein, such as nodes, routers, mobile devices, and/or any computing devices of networked computing environment 108. Although, computers 1302 may comprise any type of networked device, such as servers, switches, routers, hubs, bridges, gateways, modems, repeaters, access points, hosts, etc.

The computers 1302 can be standard tower, rack-mount, or blade server computers configured appropriately for providing computing resources. In some examples, the computers 1302 may provide computing resources 1304 including data processing resources such as virtual machine (VM) instances or hardware computing systems, database clusters, computing clusters, storage clusters, data storage resources, database resources, networking resources, and others. Some of the computers 1302 can also be configured to execute a resource manager 1306 capable of instantiating and/or managing the computing resources. In the case of VM instances, for example, the resource manager 1306 can be a hypervisor or another type of program configured to enable the execution of multiple VM instances on a single computer 1302. Computers 1302 in the data center 1300 can also be configured to provide network services and other types of services.

In the example data center 1300 shown in FIG. 13, an appropriate local area network (LAN) 1308 is also utilized to interconnect the computers 1302A-1302F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 1300, between each of the computers 1302A-1302F in each data center 1300, and, potentially, between computing resources in each of the computers 1302. It should be appreciated that the configuration of the data center 1300 described with reference to FIG. 13 is merely illustrative and that other implementations can be utilized.

In some examples, the computers 1302 may each execute one or more application containers and/or virtual machines to perform techniques described herein. For instance, the containers and/or virtual machines may serve as server devices, user devices, and/or routers in the networked computing environment 108.

In some instances, the data center 1300 may provide computing resources, like application containers, VM instances, and storage, on a permanent or an as-needed basis. Among other types of functionality, the computing resources provided by a cloud computing network may be utilized to implement the various services and techniques described above. The computing resources 1304 provided by the cloud computing network can include various types of computing resources, such as data processing resources like application containers and VM instances, data storage resources, networking resources, data communication resources, network services, and the like.

Each type of computing resource 1304 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 1304 not mentioned specifically herein.

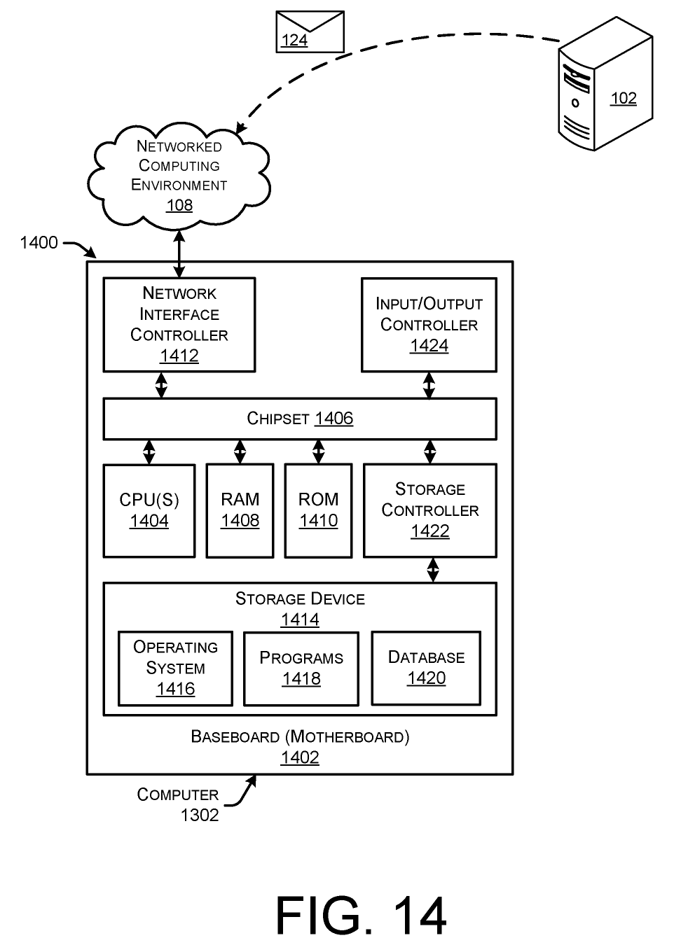

The computing resources 1304 provided by a cloud computing network may be enabled in one embodiment by one or more data centers 1300 (which might be referred to herein singularly as “a data center 1300” or in the plural as “the data centers 1300”). The data centers 1300 are facilities utilized to house and operate computer systems and associated components. The data centers 1300 typically include redundant and backup power, communications, cooling, and security systems. The data centers 1300 can also be located in geographically disparate locations. One illustrative embodiment for a data center 1300 that can be utilized to implement the technologies disclosed herein will be described below with regards to FIG. 14.

FIG. 14 shows an example computer architecture 1400 for a computer 1302 capable of executing program components for implementing the functionality described above. The computer architecture 1400 shown in FIG. 14 illustrates a conventional server computer, workstation, desktop computer, laptop, tablet, network appliance, e-reader, smartphone, and/or other computing device, and can be utilized to execute any of the software components presented herein. The computer 1302 may, in some examples, correspond to a physical device described herein (e.g., user device, computing device, device in a networked computing environment and/or data center, etc.), and may comprise networked devices such as servers, switches, routers, hubs, bridges, gateways, modems, repeaters, access points, etc. For instance, computer 1302 may correspond to a device within data center 110.

As shown in FIG. 14, the computer 1302 includes a baseboard 1402, or “motherboard,” which is a printed circuit board to which a multitude of components or devices can be connected by way of a system bus or other electrical communication paths. In one illustrative configuration, one or more central processing units (“CPUs”) 1404 operate in conjunction with a chipset 1406. The CPUs 1404 can be standard programmable processors that perform arithmetic and logical operations necessary for the operation of the computer 1302.

The CPUs 1404 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 1406 provides an interface between the CPUs 1404 and the remainder of the components and devices on the baseboard 1402. The chipset 1406 can provide an interface to a RAM 1408, used as the main memory in the computer 1302. The chipset 1406 can further provide an interface to a computer-readable storage medium such as a read-only memory (“ROM”) 1410 or non-volatile RAM (“NVRAM”) for storing basic routines that help to start up the computer 1302 and to transfer information between the various components and devices. The ROM 1410 or NVRAM can also store other software components necessary for the operation of the computer 1302 in accordance with the configurations described herein.

The computer 1302 can operate in a networked environment using logical connections to remote computing devices and computer systems through a network, such as networked computing environment 108, etc. The chipset 1406 can include functionality for providing network connectivity through a network interface controller (NIC) 1412, such as a gigabit Ethernet adapter. The NIC 1412 is capable of connecting the computer 1302 to other computing devices over the networked computing environment 108. For instance, in the example shown in FIG. 14, NIC 1412 may help facilitate transfer of data, packets, and/or communications (indicated by email 124 in FIG. 14) over the networked computing environment 108 with computer 1302. It should be appreciated that multiple NICs 1412 can be present in the computer 1302, connecting the computer to other types of networks and remote computer systems.

The computer 1302 can be connected to a storage device 1414 that provides non-volatile storage for the computer. The storage device 1414 can store an operating system 1416, programs 1418, a database 1420, and/or other data. The storage device 1414 can be connected to the computer 1302 through a storage controller 1422 connected to the chipset 1406, for example. The storage device 1414 can consist of one or more physical storage units. The storage controller 1422 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 1302 can store data on the storage device 1414 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 1414 is characterized as primary or secondary storage, and the like.

For example, the computer 1302 can store information to the storage device 1414 by issuing instructions through the storage controller 1422 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 1302 can further read information from the storage device 1414 by detecting the physical states or characteristics of one or more particular locations within the physical storage units.

In addition to the mass storage device 1414 described above, the computer 1302 can have access to other computer-readable storage media to store and retrieve information, such as models, policies, program modules, data structures, and/or other information or data. It should be appreciated by those skilled in the art that computer-readable storage media is any available media that provides for the non-transitory storage of data and that can be accessed by the computer 1302. In some examples, the operations performed by the networked computing environment 108, and/or any components included therein, may be supported by one or more devices similar to computer 1302. Stated otherwise, some or all of the operations performed by the networked computing environment 108, and or any components included therein, may be performed by one or more computer devices 1302 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, ternary content addressable memory (TCAM), and/or other optical storage, magnetic cassettes, magnetic tape, magnetic disk storage or other magnetic storage devices, or any other medium that can be used to store the desired information in a non-transitory fashion.

As mentioned briefly above, the storage device 1414 can store an operating system 1416 utilized to control the operation of the computer 1302. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 1414 can store other system or application programs and data utilized by the computer 1302.

In one embodiment, the storage device 1414 or other computer-readable storage media is encoded with computer-executable instructions which, when loaded into the computer 1302, transform the computer from a general-purpose computing system into a special-purpose computer capable of implementing the embodiments described herein. These computer-executable instructions transform the computer 1302 by specifying how the CPUs 1404 transition between states, as described above. According to one embodiment, the computer 1302 has access to computer-readable storage media storing computer-executable instructions which, when executed by the computer 1302, perform the various processes described above with regards to FIGS. 1-12. The computer 1302 can also include computer-readable storage media having instructions stored thereupon for performing any of the other computer-implemented operations described herein.

The computer 1302 can also include one or more input/output controllers 1424 for receiving and processing input from a number of input devices, such as a keyboard, a mouse, a touchpad, a touch screen, an electronic stylus, or other type of input device. Similarly, an input/output controller 1424 can provide output to a display, such as a computer monitor, a flat-panel display, a digital projector, a printer, or other type of output device. It will be appreciated that the computer 1302 might not include all of the components shown in FIG. 14, can include other components that are not explicitly shown in FIG. 14, or might utilize an architecture completely different than that shown in FIG. 14.

As described herein, the computer 1302 may comprise one or more devices, such as a computing device of security system 104, any device of networked computing environment 108 and/or data center(s) 110, and/or other devices. The computer 1302 may include one or more hardware processors 1404 (processors) configured to execute one or more stored instructions. The processor(s) 1404 may comprise one or more cores. Further, the computer 1302 may include one or more network interfaces configured to provide communications between the computer 1302 and other devices, such as the communications described herein as being performed by a computing device of security system 104 and/or other devices. In some examples, the communications may include node metric, instructions, request, attachment, packet, policy, and/or other information transfer, for instance. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 1418 may comprise any type of programs or processes to perform the techniques described in this disclosure in accordance with content concealment detection techniques. For instance, the programs 1418 may cause the computer 1302 to perform techniques for communicating with other devices using any type of protocol or standard usable for determining connectivity. Additionally, the programs 1418 may comprise instructions that cause the computer 1302 to perform the specific techniques for detecting content concealment.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

What is claimed is:

1. A computer-implemented method comprising:
receiving an email communication from one or more external devices;
extracting hypertext markup language (HTML) code from the email communication, the HTML code including a value for at least one cascading style sheet (CSS) property of the email communication, the value corresponding to a visual appearance of at least part of the email communication when rendered for display to a user;
inputting the HTML code to a large language model (LLM) classifier with a prompt to detect concealed content in the email communication;
in response to the prompt, receiving a result from the LLM classifier indicating the concealed content in the email communication relating to the at least one CSS property; and
responsive to the result, performing an action relative to the email communication to preserve network security.

2. The computer-implemented method of claim 1, wherein the value corresponding to the visual appearance of the email communication causes the concealed content to be invisible to the user when rendered for display.

3. The computer-implemented method of claim 2, wherein the LLM classifier determines the concealed content by analyzing the value of the at least one CSS property.

4. The computer-implemented method of claim 3, wherein prior to receiving the prompt, the LLM classifier is trained using an example of content concealment that includes the at least one CSS property.

5. The computer-implemented method of claim 3, wherein the at least one CSS property of the concealed content comprises:
color;
opacity;
width;
height;
overflow;
visibility; or
text-indent.

6. The computer-implemented method of claim 1, wherein performing the action relative to the email communication to preserve the network security comprises flagging the email as a suspicious email.

7. The computer-implemented method of claim 6, further comprising:
analyzing additional signals relating to the suspicious email; and
based at least in part on the analyzing the additional signals, determining a destination for the suspicious email.

8. The computer-implemented method of claim 1, wherein the LLM classifier is a binary classifier that classifies subsequent email communications as containing or not containing subsequent concealed content.

9. A system comprising:
one or more processors; and
one or more non-transitory computer-readable media storing computer-executable instructions that, when executed by the one or more processors, cause the one or more processors to:
receive an email communication from one or more external devices;
extract hypertext markup language (HTML) code from the email communication, the HTML code including a value for at least one cascading style sheet (CSS) property of the email communication, the value corresponding to a visual appearance of at least part of the email communication when rendered for display to a user;
input the HTML code to a large language model (LLM) classifier with a prompt to detect concealed content in the email communication;
in response to the prompt, receive a result from the LLM classifier indicating the concealed content in the email communication relating to the at least one CSS property; and
responsive to the result, perform an action relative to the email communication to preserve network security.

10. The system of claim 9, wherein the value corresponding to the visual appearance of the email communication causes the concealed content to be invisible to the user when rendered for display.

11. The system of claim 10, wherein the LLM classifier determines the concealed content by analyzing the value of the at least one CSS property.

12. The system of claim 11, wherein prior to receiving the prompt, the LLM classifier is trained using an example of content concealment that includes the at least one CSS property.

13. The system of claim 11, wherein the at least one CSS property of the concealed content comprises:
color;
opacity;
width;
height;
overflow;
visibility; or
text-indent.

14. The system of claim 9, wherein performing the action relative to the email communication to preserve the network security comprises flagging the email as a suspicious email.

15. The system of claim 14, wherein the computer-executable instructions further cause the one or more processors to:
analyzing additional signals relating to the suspicious email; and
based at least in part on the analyzing the additional signals, determining a destination for the suspicious email.

16. The system of claim 9, wherein the LLM classifier is a binary classifier that classifies subsequent email communications as containing or not containing subsequent concealed content.

17. A method comprising:
receiving an email communication data flow from one or more external devices, the email communication data flow including individual emails;
converting the individual emails to hypertext markup language (HTML) code;
inputting the HTML code corresponding to at least one individual email of the email communication data flow to a large language model (LLM) classifier;
inputting a prompt to the LLM classifier to detect an indication of concealed content in the HTML code;
in response to the prompt, receiving a result from the LLM classifier relating to the indication of the concealed content in the HTML code; and
responsive to the result, flagging the at least one individual email as a suspicious email.

18. The method of claim 17, wherein the HTML code includes one or more cascading style sheet (CSS) properties and the LLM classifier is configured to detect the indication of concealed content by analyzing the one or more CSS properties.

19. The method of claim 18, wherein the one or more CSS properties relates to causing a visual appearance of a part of the at least one individual email to be hidden where the at least one individual email is rendered for display to a user.

20. The method of claim 17, further comprising:
sending the suspicious email to quarantine.
